(19) United States
(12) Patent Application Publication
(10) Pub. No.: US 2026/0279054 A1
(43) Pub. Date: Sep. 17, 2026

(54) SYSTEM FOR RECORDING AN EVENT COMPRISING DISCRETE PERIODS OF MOTION

(71) Applicant: Fred Kemp, III, Warson Woods, MO (US)

(72) Inventor: Fred Kemp, III, Warson Woods, MO (US)

(21) Appl. No.: 19/565,142

(22) Filed: Mar. 12, 2026

Related U.S. Application Data
(60) Provisional application No. 63/772,031, filed on Mar. 14, 2025.

(51) Int. Cl. G06V 20/40; G06T 5/80; G06T 7/20; G06V 20/52

(52) U.S. Cl. CPC G06V 20/44; G06T 5/80; G06T 7/20; G06V 20/52

(57) ABSTRACT

A method of recording an event comprised of distinct periods of motion or activity to make available to a user distinct video snippets of the event is disclosed. The system can automatically combine the distinct periods of motion or activity in to a video file which excludes periods of inactivity. The system also allows for instantaneous or near instantaneous replay of a video snippet and enables a user to download or save [in the case of a home table] one or more selected video snippets as snippets or as a concatenated video.

### CROSS-REFERENCE TO RELATED APPLICATIONS

This application claims priority to U.S. application Ser. No. 63/772031 filed Mar. 14, 2025 and entitled “System For Recording An Event Comprising Discrete Periods Of Motion”, said application being incorporated herein by reference.

### STATEMENT REGARDING FEDERALLY SPONSORED RESEARCH OR DEVELOPMENT

Not Applicable.

### BACKGROUND

This application relates to a system and method for recording events which include discrete identifiable periods of motion, such as billiards games, to enable review of the event without any inactive periods that may exist in between the periods of motion of the event (such as a time between shots in a billiard game).

There have been quite a few recording techniques and devices for sporting games and events. Some relatively small enhancements have large impacts on the enjoyment by spectators' and participants' viewing of the games. One example is the artificial football first down marker on a television screen.

In the case of billiards, recording games has been generally very difficult and usually involves setting up a camera or a smart phone on a tripod nearby. In addition to this time-consuming process, mounting a camera on a tripod near the billiards table introduces other problems. For example, positioning the camera in any position other than directly above the billiard table necessarily means that there are many shots that will be partially or totally obscured from the camera due to the players' movements around the table. This camera positioning problem is also why it is difficult for a single camera system to perform analysis, instruction or scoring of plays for all shots as not all shots can be observed.

The only camera position that does not have this limitation is directly above the table. However, trying to place a typical camera, smart phone, or other recording device directly above the table generally is not possible because there is normally a light fixture in close proximity to the table to illuminate the playing surface (i.e., the billiard table). Given the typically short distance between the lighting fixture or ceiling and the table, to get the entire playing surface into view a wide angle or fisheye lens is required. Such a lens, by definition, also distorts the image dramatically, making all lines curved and generally causing a poor viewing experience. In the case of billiards, straight lines, including the cue sticks, the edges of the table, and the trajectories of the shots themselves, all appear bent or curved.

In addition to these obstacles, billiard games can last for several hours as is common in certain games such as one-pocket or snooker. Complete matches, involving many games, are even longer. These longer games or matches require very high media capacities that can often exceed the limitation of media that might be used to record a game or match. Such media can include, for example, smart phones and camera memory. In addition, the long recordings by their nature are undesirable because of the amount of dead or idle time as players often take a long time to analyze their next play and overall strategy. The cumulative effect of many plays and analyzations makes the resultant recordings extremely long and cumbersome.

Even if one is willing and able to record long videos, the resultant video is unruly and difficult to manage. A long video recording makes it difficult to find individual plays such as a key play in a game or match, for example. To make it more manageable, editing would be required. Most people are not able to edit such a video to do this or are inclined to do so.

Some recording techniques use a smart phone positioned somewhere around the table. When used as a camera, the phone cannot be used for calls, texts or other typical smart phone uses. In addition, a smartphone does not have the field of view required to be placed directly over the table.

Players, friends, families and spectators do not know the future. They do not know when a great play or game is going to happen. Thus, it is necessary to record the entire game. However, as outlined above, there are many problems to recording all play all the time. Unless there is full-time recording, memorable individual plays and games have a high chance of not being recorded.

Participants and instructors in nearly all sports can identify weaknesses and provide advice for improvements when there is recording. The swing in golf, a pitcher's motion in baseball and the motion of a bowler are examples that can be analyzed to improve the participant's level of play. In the case of a billiard player, the stance and stroke of the player determines how well a player can move the ball to the desired location consistently. Often, even professional players make a stroke error at key, high-stress moments in a game. If they can identify the times that this can occur, they can learn to avoid repeating these errors.

Similarly to positioning a camera to record game play, camera position for analysis, instruction or scoring purposes is always a compromise as there are positions where the player will block the view of the stroke.

Tournament and other serious players do not have time or resources to record, much less edit, games as they must remain totally focused on playing the game. Often games in certain competitions are recorded on platforms such as YouTube, but these are generally limited to the top echelons of players of the sport or those high in competition rankings. As a result, there is no practical vehicle for other tournament players and their spectators to secure video of their games or to replay motion video that has been recorded.

In addition to the players, there are often plays and games spectators would like to download or watch to replay motion that has been recorded, for example, when a play is disputed or when a play is determined to be a surprisingly good play (such as clearing a 7-10 split in bowling) People watching a live event might decide that a play or game they had just watched would be worth replaying or downloading to their smart phone, laptop or other recording device.

While there are a number of video recording improvements, none address most of the problems individually or all the problems listed above together. Therefore, there is much room for improvement.

### BRIEF SUMMARY

Disclosed is a method and system that addresses and solves the above problems. What is proposed is a full-time video system that generates video segments—also known as video snippets—of the time during which there is ball motion (i.e., a period of motion). To do this, the preferred embodiment uses a fisheye or wide angle lens positioned directly over a billiard table with sufficient field of view to record the entire playing surface. The video feed is processed by the system to “undistort” the fisheye effect, so that straight lines appear straight. The step of processing the video to remove distortion induced by the wide angle lens can occur at different times during the process: upon transmission of the recorded video to the processor, after each video snippet is identified, or after all the video snippets in the recorded video have been identified.

The video snippets can be enlarged to include a video buffer before and/or after the period of motion. These enlarged video snippets can incorporate a video buffer of, for example, ⅓ to 1 second before the motion and ⅓ to 1 second after the motion. Depending on the sport or activity being recorded, this length of the video buffer can be increased or decreased as may be appropriate. For example. The video buffer could be one (1) second or more. This video buffer can be of a fixed time, or the user could select a buffer time. This additional (optional) video buffer, with respect to billiards) records the stroke before ball contact and can offer continuity and smoothness between video snippets. The video buffer before a shot can be of a different duration than the video buffer after a shot. For example, the duration of a video buffer before a shot can be longer than the video buffer after a shot. This would allow for the system to capture the player setting up for the shot.

Because the system is recording ball motion on a full-time basis, a series of video snippets-such as the video snippets of each shot of an individual game or an entire match-can be concatenated together to generate a single video file in which with the periods of inactivity between shots are omitted. Additionally, if the duration between two shots is less than the duration of the above-noted video buffer, two adjacent snippets could contain duplicate frames in their adjacent video buffers. The system can automatically remove these duplicate frames from adjacent video buffers so that the video file produced does not have any duplicate frames. This allows any player, spectator, family member or any other interested entity to quickly download a single snippet, a selection of snippets, or a string of snippets “after the fact” with little effort. The opportunity to download a great play, game or match would, therefore, never be missed.

In this way, video files are produced that substantially eliminate “down time” or inactive time between periods of motion or activity. Thus, there should be no need for any additional editing as the video produced is already self-edited, that is the periods of inactivity have been removed, leaving only the periods of motion.

The system also preferably allows for single video snippets or a series of video snippets to be automatically replayed at the venue where the system is installed for the player(s) and others to enjoy and, if desired, download, and save. The venue can be a billiard hall or parlor, a residential home, or even an arena hosting a billiard competition. If desired, the video snippets can be replayed on a continuous basis on a monitor, for example, at a billiard tournament.

The preferred embodiment includes a user interface or application (or app) that is highly intuitive and easy for users with little or no computer/smartphone knowledge and presents a simple user interface which enables the user to identify and select the desired video snippets and to then replay and/or download the video snippets. Each video snippet can be provided with a time stamp or a snippet number, allowing the video snippets to be viewed sequentially. Additionally, the user interface can display to the user a representative image for each of the video snippets generated from the recorded video, enabling the user to easily identify and select the desired video snippets.

Because the resultant video file only includes periods of motion and, optionally, the video buffer before and after the periods motion, the video file can condense a very long game into one video that can be a few minutes or less in duration.

The system, as noted, is continuously recording, but only saves to non-transitory memory the video snippets which include the recorded ball movement and the optional video buffer before and/or after the periods of motion. So, if there is a surprisingly good game, a one-of-a-kind shot, or any other unexpected or memorable event, the single play, the entire game, or the entire match consisting of several games can be reviewed and saved “after the fact” by the user.

The system and method disclosed herein provides a unique, single-camera system. This system forms the foundation to offer many additional improvements because only a single-camera system can record all plays, all ball positions, all pockets, all player strokes no matter where the player(s) is/are positioned.

Additional improvements to the system could include the scoring games, such that the system keeps track of the score. The system could analyze cue positions and strokes in a billiard game. Further, the system could provide analysis of ball motion, such as ball speed, spin and movement around the table. The system could also referee games or institute games that enable players to test their capabilities. As can be seen, additional possibilities which can be built upon the basic foundation of the system disclosed herein may, and likely will, present themselves over time.

### BRIEF DESCRIPTION OF THE DRAWINGS

FIG. 1 is an elevational view of a billiard table, light fixture and hardware of a recording system for use with the billiard table and a monitor for displaying video snippets generated by the system;

FIG. 2 is a view similar to FIG. 1, but showing an offset instance that requires a camera with an increased angle of view for the camera or recording device;

FIG. 3 is a distorted “raw” image of a billiard table taken with a wide angle lens positioned above the table, showing the distortion of the table by the wide angle lens;

FIG. 4 is an undistorted image of a billiard table after processing to remove distortion introduced by the wide angle lens;

FIG. 5A is flowchart of the recording system;

FIG. 5B is a schematic of the components of the recording system;

FIG. 6A is a schematic representation of a video snippet of a single motion period;

FIG. 6B is a schematic representation of the video snippet of FIG. 6A, but including optional start and end video buffers on either side of the motion period;

FIG. 6C is a schematic timeline of video data recorded by the system showing three video snippets each comprised of a period of ball movement bordered by video buffers, with periods of inaction between the buffers of adjacent or sequential video snippets;

FIG. 6D shows three video snippets from FIG. 6C that have been designated to be concatenated together;

FIG. 6E is a representation of a concatenated video comprised of the three video snippets of FIG. 6D.

FIG. 6F is a representation of two concatenated video snippets wherein the end video buffer of the first video snippet and the start video buffer of the second video snippet contain duplicate frames;

FIG. 7 is an image of a user interface for selecting and then showing or saving selected video snippets;

FIG. 8 shows a user interface demonstrating the selection of video snippets of a recorded game; and

FIG. 9 is a flow chart of the operation of the user app for downloading selected video snippets.

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what I presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

The disclosed system provides a comprehensive, cost-effective method to record and automatically edit recorded video of sporting games and other events that are characterized by movement of an object such as a billiard ball, bowling ball, or a bocce ball, wherein there are periods of inactivity between movement of the object. The moving object does not have to be a ball; it could also be a dart, a chess piece, checkers, etc. This system automatically edits recorded video and omits periods of inactivity, to thereby generate video snippets of only the periods of motion with optional video buffers on either side of each period of motion that can be made for all these activities. Although the system and method are described in conjunction with a billiard game, it will thus be apparent that the system and method have applicability in many other instances.

As noted above, billiards games have been particularly difficult to record. A video recording device in any position other than directly over the table can be easily blocked by players, referees and other spectators. In fact, it is to be expected that in every game there will be plays where shots will be partially or fully blocked from view as players need a full 360-degree access to the table to affect the wide range of shots demanded of them. As a result, heretofore multiple cameras have been necessary to get an unobstructed view of all possible shots.

A recording device mounted on a high ceiling would be best and is an ideal situation. Such a position allows for a standard, undistorted lens to be used. However, because a light fixture is often placed directly over the billiard table or because the ceiling is not high enough, placing the recording device directly over the table is problematic in most cases. Thus, the best position for the recording device in this instance is to place or mount the recording device in or on the light fixture or on the ceiling directly over the table. This will, however, place the recording device too close to the billiard table for a lens having a standard field of view (e.g., a 50 mm lens) to be used with the recording device.

In addition to a light fixture or other similar obstacle, a billiard table is large and the camera's field of view must be greater than the field of view of, for example, a 50 mm lens, which typically has an approximately 47-degree field of view. As a result, the ceiling in many locations is not high enough to allow an undistorted view of the entire table using a 50 mm lens.

As a result, in most situations, a camera with a fisheye or wide-angle field of view is required. The combination of the size of the table, height of the ceiling, type and distance of the light fixture from the table determine the specific angle of view requirements for any particular situation.

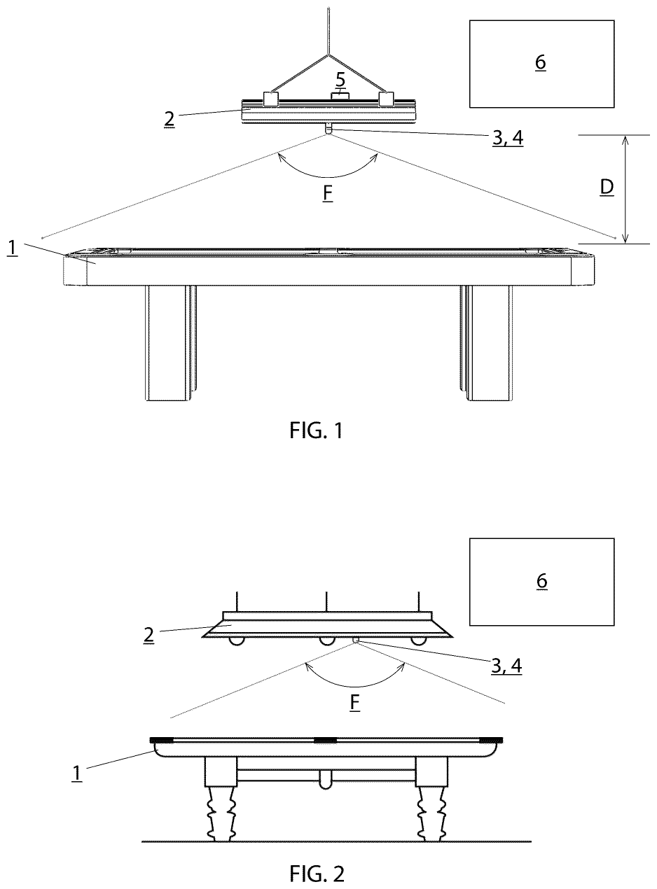

FIG. 1 is a side view of a billiard table 1 with a fixture 2 (such as a light fixture) positioned above the billiard table, and preferably generally centered over the billiard table. While fixture 2 is shown to be a light fixture, it could be any other structure, such as a low ceiling, ceiling beam, conduits, etc. that limit the distance between the lens and playing surface and, therefore, require the use of a wider angle lens.

Specifically, the system includes a recording device 3, such as a camera, fitted with a wide angle lens 4 which is shown in FIGS. 1 and 2 as being mounted to the fixture 2 and centered, as much as practical with respect to, the billiard table 1. The camera 3 with its lens 4 could also be mounted or otherwise secured to the ceiling directly above the billiard table. Note that the recording device 3, for clarity, is shown below the fixture 2. However, it is desired to recess the recording device 3 if possible into the fixture 2. For example, the fixture 2 could have a light diffusing panel that the recording device 3 could be recessed and possibly hidden into the fixture.

The recording device 3 communicates with a computer processor 5 which processes video recorded by the recording device to generate a video file, as discussed below. Additionally, the system can include a monitor 6 which is in communication with, and is controlled by the computer 5, to display video snippets processed by the computer. The communication between the processor 5, the recording device 3, and the monitor 6 can be wired (i.e., via a communication cable) or it can be wireless (such as via Wifi, Bluetooth, etc.). If desired, the processor 5 and recording device 3 can be combined, such that the hardware for the system is integrated and contained within a single housing unit. In this situation, there can be wired or wireless communication between the computer and the monitor. Alternatively, the processor 5 and monitor 6 can be integrated, and contained within a single housing unit, in which case, the communication between the computer 5 and recording device 3 can be wired or wireless. In a further alternative, the recording device 3, processor 5, and monitor 6 can all be integrated into a single unit (i. e, contained within a common housing unit). In an establishment (such as a billiard hall) with multiple billiard tables, there is a recording device associated with each table. The system can include an individual processor associated with each recording device (in which case the hardware for the system can be self-contained). Alternatively, the system can include a single central processor, and the recording device for each table will communicate with the central processor. In this variation, the establishment can include an individual monitor for each table or simply a single monitor for the establishment. The system can also be installed in a home. In such a single installation, the processor and monitor can be contained in a single housing (such as a dedicated computer or in a laptop, tablet computer, or even a smart phone). In such a single installation, the monitor is preferably a touch screen monitor.

The table 1 can be found in a variety of sizes. While billiard tables are commonly between 7 and 9 feet, there are smaller and larger tables in existence. In order to cover the entire table in a recording, the angle of view F of the lens 4 has to be significantly larger than a normal, 50 mm (stock) lens which typically has a 47 degree field of view (FOV).

While the distance D between the top of the table 1 and the lens 4 can vary, the distance D will typically be between range from about 30 to about 60 inches. The shorter the distance D is, the larger the FOV F of the wide angle lens 4 will be so that the full table top is within the FOV of the camera.

Some conditions require the recording device 3 to be offset from the center of billiard table 1 such as might be the case with an odd number of lights in the fixture 2, as shown in FIG. 2. This offset will further increase the FOV F needed so that the field of view encompasses the entirety of the table 1.

The FOV can, in some instance, be limited to the table. However, there may be instances where it is desired for the FOV to extend beyond the table. For example, it might be desired to see more of the player during a shot to analyze his or her stroke.

Therefore, the ultimate FOV F that is needed for any particular instance is dependent on a combination of all these factors (i.e., the size of billiard table 1, the distance D of the lens 4 from the top surface of the billiard table 1, the position of the lens 4 relative to the billiard table 1, and the extent of the area around the billiard table that is desired to be captured in the video.

The FOV F typically needs to be from 120 to 170 degrees or more. If the billiard table 1 is very large and if the lens 4 is very close to the table 1 and is offset relative to the table, as shown in FIG. 2, the FOV F would need to be larger, such as 180 to 200 degrees or more.

In the preferred embodiment, the wide angle lens 4 is removable from the recording device 3 so that a variety of lens with differing FOVsor focal lengths might be used as a particular situation may warrant.

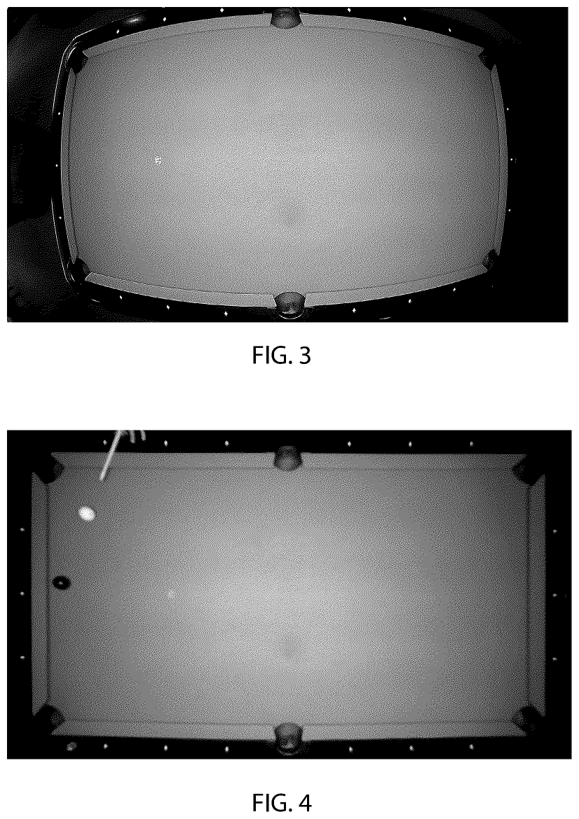

Regardless of the FOV of the lens 4, any distorted video that is generated by a wide angle lens 4 is undesirable as all objects within that field of view are distorted. Thus, all the straight lines of the billiard table, the cue stick, and the paths of movement of the balls are curved by this distortion. An illustrative distorted view is shown in FIG. 3. To mitigate this distortion, the system includes software or processes stored on the computer, which can process the video data to remove the distortion introduced from the fisheye lens 4. An illustrative image of processed video data is shown in FIG. 4. As seen, after processing, the lines distorted by the fisheye lens are “normal” (i.e., lines that should be straight, such as the cue stick and the sides of the table, appear to be generally straight).

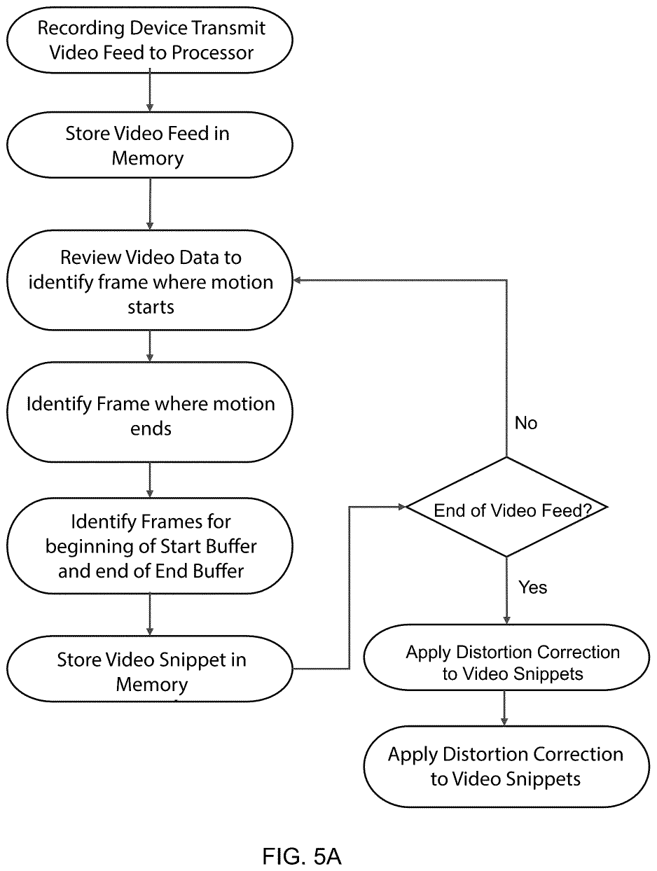

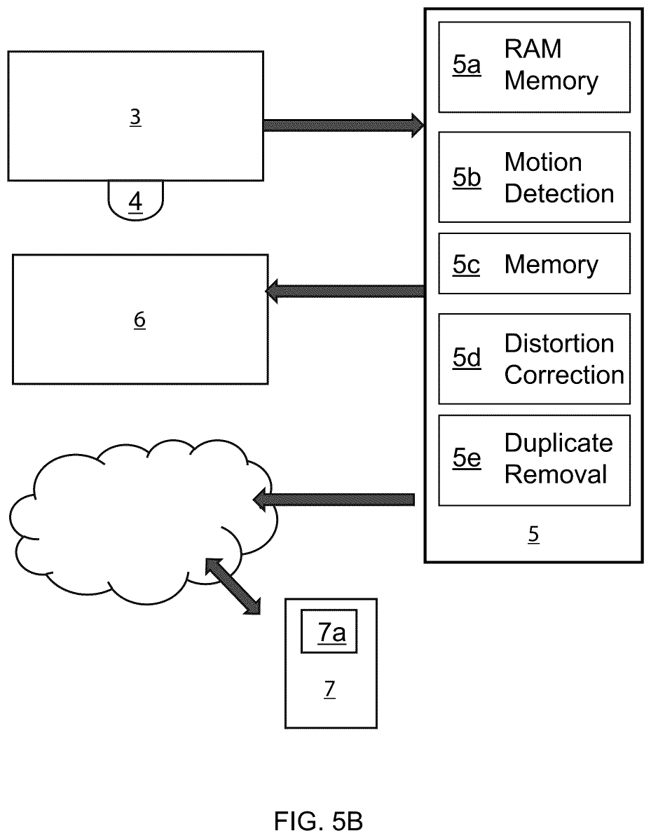

A flowchart of the recording system is shown in FIG. 5A and the components of the system are shown schematically in FIG. 5B. The process starts with the hardware as described above that features a recording device 3, such as a camera, that incorporates a wide angle lens 4 that, in the preferred embodiment, has an FOV F of between about 120 and about 180 degrees.

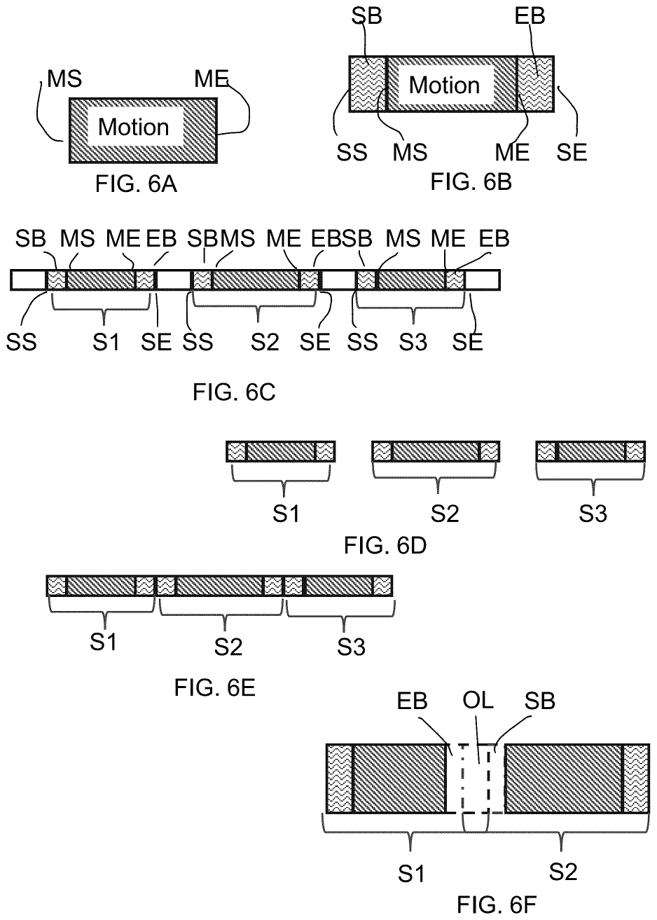

As noted above, the recording device 3 with the wide angle lens 4 continuously records images of the surface of the billiard table 1. The recording device 3 transmits the “raw” images or video data to the processor 5, which can store the video feed, for example, in RAM memory 5a (such as system RAM, GPU RAM, etc.) for further processing. The processor processes (reviews) the “raw” video with a motion detection module 5b to identify a motion start frame MS which begins a period of identified motion and a motion end frame ME which identifies the end of the period of motion. The video data between the motion start frame MS and motion end frame ME defines a motion video snippet, as shown schematically in FIG. 6A. The motion video snippet can then be saved to memory (such as system RAM, GPU RAM or similar) to be available for immediate playback. The motion video snippet can also be saved in non-volatile memory for later playback, downloading, etc. The processor 5 will continue processing (review) the video data to identify the motion start frame and motion end frame for each identified motion period in the video data. The processor will note or mark the motion start and motion end frames MS, ME for each motion period as they are identified. In the disclosed use with a billiard table, the motion detection module is adapted to specifically identify balls and determine when the balls begin moving and when the balls on the table come to a stop. By way of example, the motion detection module reviews the raw video data frame by frame and determines the start and end of ball motion by comparing the position of the balls between consecutive frames. The motion detection module can determine that there is motion if the position of at least one ball changes by a determined amount from one frame to the next, or over a determined number of frames (such as 5 frames). The motion detection module will determine that ball motion has ended when there is no substantial movement of any ball on the table from one frame to the next, or over a determined number of frames (such as 5 frames). Software or programming modules for identifying specific types of objects and determining their motion are well known, and any desired motion detection module can be used. However, it is important that movement other than ball movement-such as player movement, passersby, cue movement and other non-ball movement-is not considered when determining the start or end of motion, as that would then result in undesired video being captured.

For example, in a billiard game, the motion detection module 5b can determine the frame when the cue ball is initially struck. This would indicate when ball movement begins. The motion detection module will identify the first frame of motion of the billiard balls, and will note where in the video data motion starts. This will be the motion start frame MS for a motion period, and can be specifically identified with a mark or tag, by noting the time stamp of the frame, or in any other manner known to one of skill in the art. The motion detection module 5b will continue to process the video frame by frame to determine when the billiard balls on the table come to a stop for the identified motion period, and will identify the last frame of motion of balls. This last frame will be an motion end frame ME, and can be specifically identified with a mark or tag, by noting the time stamp of the frame, or in any other manner known to one of skill in the art. The video between these motion start frame MS and the motion end frame ME will, as noted, define a period of motion and a can be saved as a motion video snippet. This process continues until the complete video data is reviewed.

The motion detection module 5b can be operated to generate an enlarged motion video snippet by optionally including a start video buffer SB before the motion start frame MS and/or an end video buffer EB after the motion end frame ME. In this instance, the system identifies the start frame SS of the start video buffer SB and the end frame SE of the end video buffer EB. The start and end video buffers SB, EB can be a determined amount of time or a determined number of frames of video that represent the desired durations of the video buffers. For example, if the desired duration of the video buffers is ½ second, and if the video is shot at 30 frames per second, the processor will identify the frames that are 15 frames before the motion start frame MS and 15 frames after the motion end frame ME. These identified frames will be the start buffer start frame SS and end buffer end frame SE, respectively, for the enlarged video snippet. This can be done by marking or tagging the first frame of the start video buffer and last frame of the end video buffer or by noting time stamps in the video data, or by any other method known to one of skill in the art. The video data between the start buffer start frame SS and the end buffer end frame SE defines an enlarged motion snippet which includes, as shown schematically in FIG. 6B a single period of motion bordered by a start buffer SB and an end buffer EB. The system then stores the enlarged snippet as a video snippet to non-transitory memory, as described above.

In addition to storing the video snippet (either a motion only video snippet or an enlarged video snippet), the system can store a still image of the motion start frame MS as an image file to be associated with the saved video snippet. This still image will be representative of the video snippet and will be used, as discussed below, by users to download and/or display selected video snippets. The system then repeats this process until the end of the video data is reached. The still image is preferably the motion start frame, as noted, but could, if desired, be any frame in the snippet.

The start video buffer SB and end video buffer EB can be any desired duration. For example, the start and end video buffers can be as short as ¼ second, ⅓ second, or 1/2 second, and up to as long as 3-5 seconds or even more as the activity might dictate. Further, the start video buffer and end video buffer do not need to be of the same length. The video buffers are desired for continuity of the resulting video file produced by the system. Inclusion of the start and/or end video buffers can avoid jerkiness in the resulting video. Additionally, in a billiard setting, the video start buffer can show at least some of the player's stroke. Preferably, the duration of both of these video buffers are adjustable and can be selected by the user.

The determination of the start buffer start frame SS and end buffer end frame SE can be determined as each motion period is identified, as shown in FIG. 5A. Alternatively, the video buffer start and end frames SS, SE can be determined after some or all of the motion periods for a video data are identified.

FIG. 6A shows a schematically shows a single motion video snippet comprising the frames (or data) between, and inclusive of, the motion start frame MS and the motion end frame ME. FIG. 6B schematically shows an enlarged motion video snippet comprising a start video buffer SB, period of motion, and an end video buffer EB. The enlarged video snippet thus includes the frames (or data) between, and preferably inclusive of, the start buffer start frame SS and the end buffer end frame SE. FIG. 6C schematically represents a “raw” video feed that has been processed by the motion detection module to identify three enlarged video snippets S1-S3, with the second enlarged video snippet S2 separated from the first and third enlarged video snippets S1 and S3 by a period of inactivity. FIG. 6D shows the 3 extended snippets extracted from the video feed which have been designated to be joined or concatenated. Lastly, FIG. 6E represents the three enlarged video snippets joined or concatenated to produce a video file comprised of the three video snippets. The area between video snippets shown in FIG. 6C before and after each video snippet represents “idle time” which is not desired or saved. The system saves each video snippet (whether it be a motion-only video snippet or an enlarged video snippet) to either the RAM memory 5a (such as system RAM, GPU RAM, etc.) or a non-volatile memory 5c of the processor. The non-volatile memory can be, for example, read-only memory (ROM), flash memory (EEPROM), magnetic storage (such as a disk drive). Other types of non-volatile memory can be used as well.

As noted above, the inclusion of the start and end video buffers is optional. If the start and end video buffers are to be excluded, then the video snippet will include just the motion video snippet schematically shown in FIG. 6A.

The saved video snippets are then processed by a distortion correction module 5d of the processor 5. The distortion correction module processes the video on a frame-by-frame basis to remove distortion caused by intrinsic and extrinsic properties of the wide angle lens 4. The distortion correction process often requires a larger field of view than the final field of view. Thus, the FOV F of the wide angle lens 4 can encompass an area surrounding the table, whereas the FOV F of the end processed video (as seen in FIG. 4) is preferably limited to the table itself, potentially with a few inches of boarder around the table although this can vary. As noted above, it may be desirable to have a final FOV F which includes more space around the table, to, for example, capture more of the player's body in the video so that the player or a coach can review and critique the player's technique. This difference can be seen by comparing the images of FIGS. 3 and 4. As seen in FIG. 3, the area of view taken in by the wide angle lens extends beyond the edges of the billiard table, and the edges of the table appear bent (as would a cue stick if it were in the image) due to the distortion inherent in the wide angle lens. Although FIG. 3 shows a field of view that does not extend much beyond the side edges of the table, depending on the angle of view of the lens used, the recording device could capture a greater area around the table. Upon processing via the distortion correction module 5d, the lines which should appear straight (such as the edges of the table and the cue stick) become generally straight and the area of the field of view is reduced to just beyond the perimeter of the table, as seen in FIG. 4. The distortion correction process is well known, and any desired distortion correction algorithm can be used. As seen by comparing FIGS. 3 and 4, in addition to correcting for distortion caused by the wide angle lens, the distortion correction module 5d can also effectively crop the image such that only a small or limited area beyond the edges of the table remains in the saved video.

Lastly, as noted above, the system generates a “still” picture file (i.e., as jpg or other picture format) indicative of the motion or activity in the motion portion of the video snippet. This still picture will be the representative picture for its associated video snippet and is then associated with its respective snippet.

As noted above, the still picture is preferably the motion start frame MS for each video snippet, but could be any desired frame from the video snippet. The system then saves the video snippet and its associated still image to memory.

This can either be transient volatile memory (such as RAM) or more permanent, non-volatile, non-transient memory.

The order of the video processing can vary. For example, the distortion correction module can process the video after the processing by the motion detection module and thus after the snippets have been generated. This is more efficient and reduces CPU computation time as fewer frames need to be processed by the distortion correction module. Alternatively, the distortion correction module could process the video as the video is recorded. In this instance, distortion correction would be done first on a full-time basis. Motion detection could then be conducted on the video that has been processed by the distortion module. In this instance, the motion detection module would be able to process undistorted video frames. Alternatively, there may be other methods to detect ball motion and undistort the video other than the preferred embodiment. In addition, a camera lens that mechanically corrects distortion could also be substituted for the distortion correction module.

After the video feed is processed by both the motion detection module and the distortion correction module, the final video snippets can be created and saved to non-volatile memory 5c or one or more volatile memory modules 5a (system RAM, DRAM, SDRAM, VRAM, GPU RAM, etc.) in the processor 5.

Based on this process, anytime there is ball motion, an undistorted video snippet is created that includes the motion period and the optional start and end buffers. A library of the snippets and their associated representative still images are thus created automatically and stored. Although the non-volatile memory 5c is shown as being part to the processor 5, the non-volatile memory could be remote from the processor 5 or even cloud based. If the processor is processing video data for multiple tables, each video snippet as associated with the particular table.

The processing of the video feed by the processor 5 can occur after a game is complete. However, preferably, the video feed is processed as the game is being played. This will allow the video snippets (whether the video snippets are motion-only video snippets or the enlarged motion snippets) to be available almost immediately for playback on a monitor 6 and/or for download via a user device 7 having an user app or interface 7a. Further, the order of processing the video data to identify the motion periods, identify the beginning and end frames of the optional start and end buffers, and removing distortion (if a wide angle lens is used) can be varied. Virtually any logical order of processing the video data to generate the video snippets would be acceptable.

Preferably, only the video snippets are saved to (either volatile or non-volatile) memory. The raw video data need not be saved. Once the video snippets are generated and saved, the remaining raw data can be discarded.

Further, if desired, video snippets could be removed from the memory 5c of the processor after a desired period of time, such as one day, one week, one month, etc. This would reduce the size of the storage device needed to store the motion snippets.

After video snippets have been recorded and stored in memory, they are made available to be downloaded by a user using a user device 7, such as a smart phone, a tablet, a laptop computer, desktop computer, a game system, or any other type of computing device. As alluded to above, in a home system, the processor 5 can be the user device 7. As can be appreciated, the user device will have means for communicating with the system, a memory, and an input device (such as a touch screen, mouse, stylus, or keyboard). Selected video snippets can be downloaded using a user app 7a which is stored on the user device 7. Preferably, the user device 7 communicates with the processor 5 via a wireless connection (such as WiFi, Bluetooth, etc.). The connection can, alternatively, be a wired connection.

There are multiple ways in which a user can access the interface 7a. In a preferred method, the system can be made available as Software-as-a-Service (Saas). In this manner, each table 1 can include a unique identifier which identifies the table. The identifier can be a numeric or alphanumeric identifier, or it can be bar label, RFID tag, or quick response (QR) code which the user can scan. In the first three instances, the user would be directed to a web site which would launch the system for the user. In the preferred embodiment, the web is run locally on the processor 5 through a wireless connection to user device 7 to maximize throughput and avoid Internet connection restrictions or other issues. The system would then prompt the user to enter the identifier or to scan the bar code or RFID tag. In an installation with just one table (such as a home installation), the table identifier can be stored with the app or interface 7a. If a QR code is used, the QR code would contain the table identifier and, upon scanning, would direct the user to the URL for the system and direct the system to bring up the data for the particular table. In another alternative, the system can rely use a GPS system of the user device to identify the location of the billiard table establishment or even to identify a particular billiard table within an establishement, and the user is then associated with the particular table by the user's and table's precise GPS location.

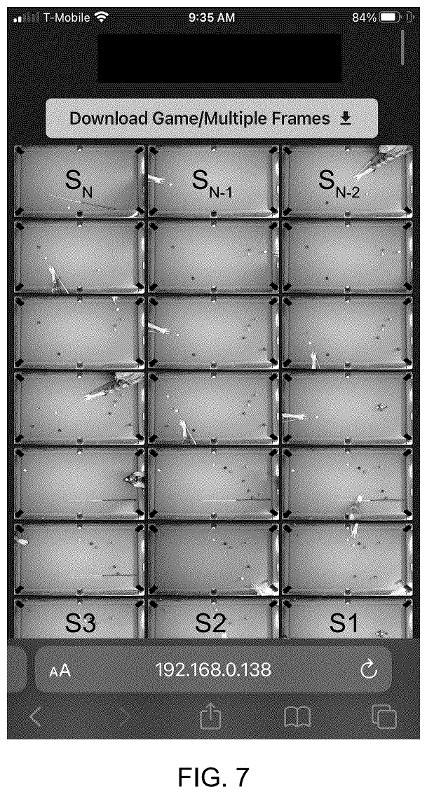

Once the user is connected to the system and the table has been identified to the system, the user is presented with a user interface as shown illustratively in FIG. 7. As seen, the user interface presents a series of still images in rows, with each still image being the representative image for each particular video snippet. The images are presented in descending time order, for example with the still image for last video snippet Sn being in the upper left corner. The video snippets Sn-1, Sn-2, . . . S1 are then proceed from left to right and top to bottom, with a lower row containing the images of the earlier shots played (and thus with the first few snippets S3-S1 being in a row lower than the first row). The image of FIG. 7 shows a 3×n grid of images, with 6 ½ rows being visible. If there are more than, in this instance, 21 shots in the game, the user can scroll down to see the first frames of earlier shots, such as when the balls are racked at the start of a game. Although FIG. 7 shows the video snippets as last to first starting in the top left, the snippets could be arranged in a different order, such as chronological order (with the first shot shown in the top left). The still images are presented as JPGs or other still image format, enabling a user to easily zoom into and examine each image, for example, to see the ball position in a selected image in more detail.

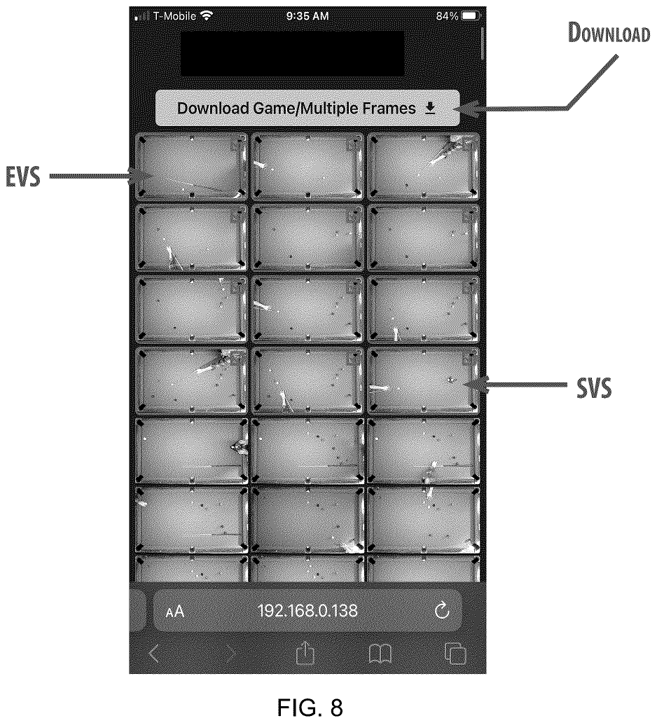

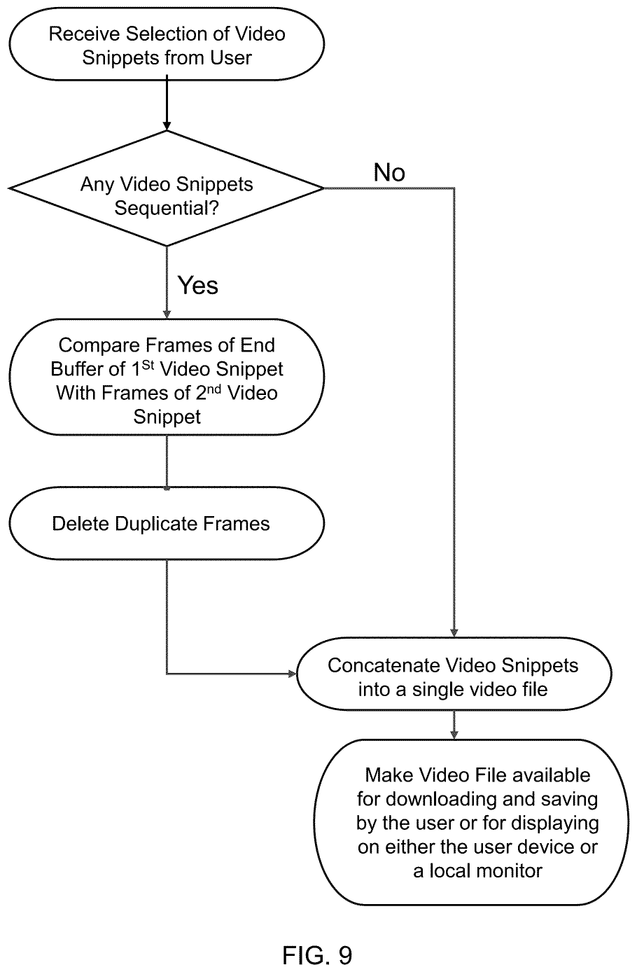

Turning to FIG. 8, the user selects desired snippets to be played or downloaded. For example, the user can select a start video snippet SVS (such as when the balls are racked and right before the motion to break the rack) and an end video snippet EVS. In the preferred embodiment, when the start and end video snippets are selected, the app 7a will then automatically select all the images between the start and end snippets. This would enable the user to play or download a full game or a series of shots in order. FIG. 8 shows 12 frames representing 12 snippets having been selected. Alternatively, the interface could enable the user to select two or more distinct snippets (i.e., snippets which are not adjacent each other). Finally, the user could select and download a single snippet. The representative images are, as noted above, saved as still images files (e.g., jpgs). The user can thus enlarge selected images so that the images can be more clearly seen to enable the user to distinguish between images more easily and to select the desired video snippet(s). Similarly, when the images are reduced in size, more images are shown on the screen.

The user interface can also automatically suggest the snippets to download. For example, the system could automatically identify the video snippet containing a rack before breaking ball motion and identify the last video snippet when the last ball is shot into a pocket and suggest/highlight all the video snippets in between the two suggested video snippets.

Once the user has selected the desired video snippets, the user hits, or otherwise selects, the “download” button at the top of the screen. When the “download” button is selected, the interface/app 7a will ask the user if the video snippets are to be displayed on the user device 7 or downloaded. If the user opts to display the selected video snippets, the system can display the selected video snippets directly on the user device 7. Alternatively, the system can cause the video snippets to be displayed on the monitor 6 distinct from the user device 7. The monitor 6 can be a specific monitor associated with the table. Alternatively, the system can play the selected video on one or more pre-determined monitors in the establishment.

Due to the manner in which the billiard game is played (i.e., due to the time between successive shots) and due to the length of the start and end buffer times, a portion of a start buffer of one enlarged motion snippet could overlap to some degree with a portion of the end buffer of the prior enlarged motion snippet. The two adjacent snippets would then have one or more duplicate fames. This overlap is shown schematically in FIG. 6F, where a portion of the end buffer EB of an enlarged motion snippet S1 and a portion of the start buffer SB of enlarged motion snippet S2 overlap in time. The two video snippets thus have common, or duplicate, frames in the overlap area OL. Viewing such two snippets in succession would be incongruous, as it would have a repetitive section of video (due to the duplicate frames). Thus, after the user selects the download button, the system determines if any of the selected motion snippets are sequential (i.e., follow each other in time and contain duplicate frames). If so, then it processes adjacent snippets via a duplicate removal module 5e. The duplicate removal module will compare the frames of the end buffer of a first enlarged motion snippet with the frames of the start buffer of the next succeeding enlarged motion snippet to determine if there are any duplicate frames. Any duplicate frames will then be removed from one of the two snippets. Obviously, if the user selects only one snippet, or if the user selects snippets which are not consecutive in time, then the enlarged motion snippets do not need to be processed via the duplicate removal module.

Once duplicate frames have been identified and removed, the system assembles or concatenates the selected snippets into a single video file, and makes the video file available to the user for viewing and/or downloading and saving to the user's device 7, or to be emailed or otherwise transmitted by the user to a recipient, etc. This resulting video file also can be saved to the system's RAM, GPU RAM or non-volatile memory.

The app 7a can be used to replay the selected video snippets or the generated video file comprised of concatenated video snippets either directly on the user device or on the monitor 6 as noted above. The app can play the entire video file at a constant (regular) speed. In an alternative, it may be desirable to have the start video buffer and/or the end video buffer play faster than the motion portion to save time. Conversely, the motion video may be played at a slower speed to highlight the action. For example, a puck being blocked by a goalie may have 1X speed for the video start buffer, ½ speed for the motion video and 1X speed for the end video buffer. So that the system knows when to change the speed of the playback, the video snippet is saved with the data indicating the motion start frame MS, the motion end frame ME, the buffer start frame SB, and the buffer end frame SE.

The video is preferably recorded in HD format (1,920×1,080), but could be recorded in any desired resolution. The file sizes of, for example, a 1 minute video can thus be large. Such large videos can increase the processing time required to concatenate video snippets and remove duplicate frames and the time required to transmit a concatenated video wirelessly. Such large videos can also consume significant space in a user's device. Thus, the system can reduce the size of the video prior to saving the video to disk (i.e., to the non-volatile memory). Thus, when a user selects video snippets to concatenate, the user is concatenating video snippet files that have been reduced in size. If desired, the system can be configured to enable the user to select as to whether or not the video snippets should be reduced and if so, the extent to which they should be reduced.

In a variation, the system can automatically play or replay video snippets on the monitor 6 after the video snippets are processed. To facilitate instantaneous or near instantaneous playback of the video snippets, the video snippets are preferably played back while still in system RAM and or GPU RAM rather than being played from a non-volatile memory after being saved to the non-volatile memory. This could be separate and apart from the use of the app by the user and offer continuous replays. Replaying of video snippets by the system would allow those in the establishment or at another venue such as a private home to see repeats of shots as they are played. In the preferred embodiment, the most recent video snippet or snippets are automatically replayed and as more motion video snippets are created, the system will cycle through the videos snippets playing new video snippets as they are generated.

In a variation, the monitor can be have a split screen which can be divided into two, four or more sections, with each section of the monitor displaying a separate video snippet. For example, in a monitor having four sections, four video snippets V1-V4 occurring sequentially in time can be shown each of the four sections.

The monitor can, for example, play each video snippet in its section, and as a video snippet (i.e., video snippet V1) is shown, the next video snippet V2 can be played, and the video snippet V1 just played can be replaced by another video snippet V5 occurring sequentially in time after video snippet V4. In this manner, the played video snippets will cycle around the monitor. Alternatively, after video snippet V1 plays, video snippets V2-V4 could move forward, and the video snippet V5 could be introduce in the section where video V4 was. In this manner, the video snippets will always be played in the same section of the monitor. In either case, preferably only one video snippet plays at a time. In a further alternative, the system could randomly line up video snippets to play, such that the video snippets played are not necessarily sequential in time. In yet a further alternative, in for example, a billiard hall, one of the sections of the monitor can be used to show advertising for the billiard hall, advertising for the system, or can display a QR code or web address enabling patrons to access the system. In this manner, the monitor can provide information as to how to access the system and app to others in the facility. The number or time duration of the snippets being played can be adjusted as desired. In addition, the duration of the video buffers can also be adjusted as well as the speed at which the video buffers are played.

The automatic playing of snippets can be overridden by a selection by a user of specific snippets. That is, a user through the app can select video snippets to play, as described above, and then select that the video snippets be played on the monitor. In this instance, the user's selection will override the systems automatic playing of snippets and the system will then show the video snippet(s) selected by the user. After the system completes playing the user's selected video snippet(s), the system can return to playing the video snippets it selects.

The system can include other features. For example, in situations where rights of privacy might be a concern, the system can include an anonymizer module, which would process the video data to blur the faces and/or bodies of individuals which might appear in the video. If the recording device 3 is directly above the table, it is more likely that the top (and back) of a player's head and the player's hands and arms might be visible. This may make it more difficult to identify players. However, players may nonetheless have features that still enable them to be identified. It may be possible to enable the anonymizer module to blur out whole heads and arms to further reduce the potential of a player being recognized. Additionally, the system does not normally include a microphone, and thus the video contains no sound. However, if desired, a microphone or other sound pickup could be provided to associate sound with the video. As an alternative, the system could process sound data so that only the sound of the balls on the table are heard.

As can be seen, disclosed is a system which will record a game (such as a billiard game), automatically identify periods of motion in the game and generate a video snippet that includes only the periods of motion (and optional start and end video buffer). The automatically generated concatenated video file would thus not include periods of inactivity. The user can select desired video snippets to concatenate into a single video file that can be downloaded by the user. The user can also select video snippets for the system to play on the associated monitor. Further, the system can play automatically play snippets that have been recorded and saved to its memory. Such automatically played snippets can be played in a random or sequential order. The system thus provides a recording system which right out of the box automatically edits the original video data and produces a finished product comprised of video snippets as described above and which omits the periods of inactivity between the video snippets without any editing required.

The system is disclosed with respect to a billiard table, which, in most instances, would require a camera with a wide angle lens. However, in some situations, the ceiling may be tall enough to avoid the need for a wide-angle lens. In such a situation, distortion correction would not be required.

Although described for use with respect to billiards, the system could have applicability in other sports or activities, such as chess, darts, bowling, golf (at the tee or putting green), soccer or hocky (at the goal). In activities such as darts or bowling, the positioning of the camera would need to be changed, and it may be desirable to have two cameras-one which records the throw of the dart or bowling ball, and a second which records the strike of the dart on the target or impact of the bowling ball on the bowling pins. The system could also have applicability in nature activities, such as bird watching. In this instance, the camera can be focused on a specific area, such as a bird feeder, a nest, or a portion of a tree, to concatenate video snippets of recorded activity at the monitored location. This would allow a user to review activity in the monitored area without having to fast forward through periods of inactivity in the monitored area. In this used, the video snippets could be provided with a date and time tag, so that the date and time of the various snippets could be easily ascertained.

Other uses could include vehicles passing through a gate (such as a toll gate) or security video, wherein saving only video in which there is activity would significantly reduce the amount of video data saved. In some of these alternative uses, it may not be necessary to record the video using a wide-angle lens. In such a situation, the distortion correction steps would not be necessary.

The process described herein is scalable. It can dramatically reduce heretofore videos that incorporate long periods of extended inactivity to short videos containing motion without traditional time-intensive editing. The process can be scaled upward to include not just one match of two players, for example, but many matches that include hundreds of players such as may be found in a billiard tournament. In that case, for example, spectators can review all the condensed games played on a particular day on a very large monitor, possibly at an accelerated speed. In this way, many games could be viewed and games of interest could be downloaded.

As various changes could be made in the above constructions without departing from the scope of the invention, it is intended that all matter contained in the above description or shown in the accompanying drawings shall be interpreted as illustrative and not in a limiting sense. This example is merely illustrative.

1. A method of recording an event comprised of distinct periods of motion or activity to make available to a user distinct video snippets of the event; the method comprising:
a. recording the activity using a video recording device;
b. transmitting recorded video of the activity to a processor;
c. the processor processing the recorded video to identify a period of motion comprising:
i. identifying a motion start frame where detected motion starts; and
ii identifying an motion end frame where the detected motion ends;
wherein video data between the motion start frame and the motion end frame defines a video snippet;
d. repeating steps (c) until the end of the recorded video is reached;
and e. saving the video snippet to a memory or playing the video snippet on a monitor, said steps of saving and playing occurring either between steps (c) and (d) or after step (d).

2. The method of claim 1 further including the steps of:
f. receiving from a user a selection of one or more of the video snippets;
g. concatenating the selected video snippets into a single video file; and
h. making the single video file available for download and/or playing by the user.

3. The method of claim 1 further including a step of including one or both of a video start buffer and a video end buffer with the video snippet, the video start buffer and video end buffer each being of a defined time length or comprising a defined number of frames; said step comprising:
determining a start buffer start frame for the video snippet, said start buffer start frame being a frame in said recorded video which is said defined length or defined number of frames before said motion start frame;
determining an end buffer end frame for the video snippet, said end buffer end frame being a frame in said recorded video which is said defined length or defined number of frames after said motion end frame;
wherein the video snippet further includes frames of the recorded video between the start buffer start frame and the end buffer end frame.

4. The method of claim 3 comprising receiving from a user a selection of two or more video snippets to be saved to a desired user device or to be viewed; the method further comprising:
a. determining if selected video snippets are sequentially consecutive;
b. if the video snippets are sequentially consecutive,
i. comparing the end buffer of a first video snippet with the start buffer of a second video snippet to identify duplicate frames; and
ii. removing the duplicate frames from one of the two video snippets;
such that the video file does not have duplicate frames.

5. The method of claim 1 wherein each video snippet is provided with a time stamp or a snippet number, allowing the video snippets to be viewed sequentially.

6. The method of claim 2 wherein the step of receiving the selection of video snippets from the user comprises displaying to the user a representative image for each of the video snippets generated from the recorded video.

7. The method of claim 1 wherein the step of saving the video snippet to memory comprises saving the video snippet to a non-volatile memory.

8. The method of claim 1 wherein the event to be recorded is carried out on a horizontal surface and the video recording device is positioned directly above the horizontal surface; the video recording device comprising a lens having a sufficient angle of view or focal length to enable the video recording device to capture the full horizontal surface.

9. The method of claim 8 wherein the lens is a wide angle lens, the method further including a step of processing the recorded video to remove distortion induced in the video by the wide angle lens.

10. The method of claim 9 wherein the step of removing distortion occurs upon transmission of the recorded video to the processor, after each video snippet is identified, or after all the video snippets in the recorded video have been identified.

11. The method of claim 1 comprising displaying one or more selected video snippets on a monitor that is in communication with said processor.

12. The method of claim 11 comprising receiving from a user a selection of video snippets to be displayed on said monitor.

13. The method of claim 11 wherein said step of displaying one or more selected video snippets comprises said processor automatically displaying video snippets on said monitor; said processor causing said video snippets to be played in a sequential or random order.

14. The method of claim 11 wherein the system suggest the snippets to download, said step of suggesting snippets comprising identifying an initial snippet and a final snippet and selecting all snippets between the initial and final snippet.

15. A method of recording an event comprised of distinct periods of motion or activity to make available to a user distinct video snippets of the event; the activity being carried out on a generally horizontal surface, the method comprising:
a. recording the activity using a video recording device positioned directly above the generally horizontal surface, the video recording device comprising a wide angle lens having a focal length sized so as to capture the entire horizontal surface on which the activity is carried out;
b. transmitting recorded video of the activity to a processor;
c. the processor processing the recorded video to identify a period of motion comprising:
i. identifying a motion start frame in the recorded video where detected motion starts; and
ii identifying a motion end frame in the video data where detected motion ends;
d. repeating step (c) until the end of the recorded video is reached;
e. processing the recorded video to remove distortion induced in the video by the wide angle lens;
f. wherein recorded video between the motion start frame and the motion end frame defines a video snippet;
g. saving the video snippet to a non-volatile memory and/or playing the video snippet on a monitor.

16. The method of claim 15 wherein the step of removing distortion occurs as video is recorded, after each video snippet is identified, or after all the video snippets in all the video data have been identified.

17. The method of claim 15 further including a step of including one or both of a video start buffer and a video end buffer with the video snippet, the video start buffer and video end buffer each being of a defined time length or comprising a defined number of frames; said step comprising:
determining a start buffer start frame for the video snippet, said start buffer start frame being a frame in said recorded video which is said defined length or defined number of frames before said motion start frame;
determining an end buffer end frame for the video snippet, said end buffer end frame being a frame in said recorded video which is said defined length or defined number of frames after said motion end frame;
wherein the video snippet further includes frames of the recorded video between the start buffer start frame and the end buffer end frame.

18. A method of recording an event comprised of distinct periods of motion or activity to make available to a user distinct video snippets of the event; the method comprising:
a. recording the activity using a video recording device;
b. transmitting recorded video of the activity to a processor;
c. the processor processing the recorded video to identify a period of motion comprising:
i. identifying a motion start frame in the recorded video where detected motion starts; and
ii identifying a motion end frame in the recorded video where detected motion ends;
wherein the recorded video between the motion start frame and the motion end frame defines a video snippet; and
d. repeating step (c) until the end of the recorded video is reached;
e. the processor transmitting one or more of the video snippets to be displayed on said monitor.

19. The method of claim 18 further including a step of including one or both of a video start buffer and a video end buffer with the video snippet, the video start buffer and video end buffer each being of a defined time length or comprising a defined number of frames; said step comprising:
determining a start buffer start frame for the video snippet, said start buffer start frame being a frame in said recorded video data which is said defined length or defined number of frames before said motion start frame;
determining an end buffer end frame for the video snippet, said end buffer end frame being a frame in said recorded video data which is said defined length or defined number of frames after said motion end frame;
wherein the video snippet further includes frames of the recorded video between the start buffer start frame and the end buffer end frame.

20. The method of claim 19 further including
i. comparing the video end buffer of a first video snippet with the video start buffer of a second video snippet which sequentially follows the first video snippet to identify duplicate frames; and
ii. removing the duplicate frames from one of the two video snippets;
such that a video file does not have duplicate frames; and
iii. concatenating the video snippets to generate a video file, which does not have duplicate frames.

21. The method of claim 18 wherein the activity to be recorded is carried out on a horizontal surface and the video recording device is positioned directly above the horizontal surface; the video recording device comprising a wide angle lens having a sufficient angle of view or focal length to enable the video recording device to capture the full horizontal surface; wherein the method further includes a step of processing the recorded video to remove distortion induced in the video by the wide angle lens.

22. The method of claim 20 wherein the step of removing distortion occurs upon transmission of the recorded video to the processor, after each video snippet is identified, or after all the video snippets in the recorded video have been identified.
